(19) United States
(12) Patent Application Publication
(10) Pub. No.: US 2019/0330437 A1
(43) Pub. Date: Oct. 31, 2019

(54) POLYMER FOAM INCLUDING NANO-CRYSTALLINE CELLULOSE

(71) Applicant: Owens Corning Intellectual Capital, LLC, Toledo, OH (US)

(72) Inventors: Venkata S. Nagarajan, New Albany, OH (US); Xiangmin Han, Stow, OH (US); Yadollah Delaviz, Lewis Center, OH (US)

(21) Appl. No.: 15/966,190

(22) Filed: Apr. 30, 2018

(51) Int. Cl. C08J 9/14

(52) U.S. Cl. CPC C08J 9/146; C08J 2203/202; C08J 2201/03

(57) ABSTRACT

A polymer foam is provided. The polymer foam is formed from a composition that includes a polymer, 2% to 10% by weight nano-crystalline cellulose based on the total weight of the polymer foam, and at least one blowing agent. The polymer foam exhibits a reduced thermal conductivity (k-value) and a higher water vapor permeability as compared to an otherwise identical polymer foam without nano-crystalline cellulose.

### FIELD

The present disclosure relates to polymer foams, and more particularly, to polymer foams that include nano-crystalline cellulose, which exhibit improved water vapor permeability and reduced thermal conductivity.

### BACKGROUND

Polymer foams are useful in a wide variety of applications such as thermal insulation, in cushions, as packaging, and as adsorbents. Extruded polymer foams are generally made by melting a polymer together with any desired additives to create a polymer melt. A blowing agent is mixed with the polymer melt at an appropriate temperature and pressure to produce a foamable gel mixture. The foamable gel mixture is then cooled and extruded into a zone of reduced pressure, which results in a foaming of the gel and the formation of the desired extruded polymer foam product. In the context of thermal insulation, it is desirable to minimize the thermal conductivity of the polymer foam to improve the insulating capability of the polymer foam, and to control the water vapor permeability of the polymer foam to reduce the risk of mold growth due to moisture condensation and/or accumulation.

### SUMMARY

Disclosed herein are polymer foams, compositions for forming polymer foams, and methods of making polymer foams. The compositions for forming the polymer foams, as well as the resulting polymer foams, include nano-crystalline cellulose, which reduces the thermal conductivity and improves the water vapor permeability of the polymer foams. To illustrate various aspects of the present disclosure, several exemplary embodiments of the polymer foams, compositions for forming the polymer foams, and methods of making polymer foams are provided.

In one exemplary embodiment, a polymer foam is provided. The polymer foam is formed from a composition that includes a polymer, 2% to 10% by weight nano-crystalline cellulose based on the total weight of the polymer foam, and at least one blowing agent. The polymer foam exhibits a reduced thermal conductivity (k-value) and a higher water vapor permeability as compared to a comparative polymer foam without nano-crystalline cellulose.

In one exemplary embodiment, a composition for forming a polymer foam is provided. The composition includes a polymer, 2% to 10% by weight nano-crystalline cellulose based on the total weight of the solids of the composition, and at least one blowing agent.

In one exemplary embodiment, a polymer foam composition is provided. The polymer foam composition includes an alkenyl aromatic polymer and 2% to 10% by weight nano-crystalline cellulose based on the total weight of the polymer foam composition. When the polymer foam composition is formed as a foam, the polymer foam exhibits a reduced thermal conductivity and a higher water vapor permeability as compared to a comparative polymer foam without nano-crystalline cellulose.

In one exemplary embodiment, a method of making a polymer foam is provided. The method includes preparing a polymer melt comprising a polymer and nano-crystalline cellulose, incorporating at least one blowing agent into the polymer melt to form a foamable mixture, and extruding the foamable mixture through a die into a region of reduced pressure to form the polymer foam. The polymer foam exhibits a reduced thermal conductivity (k-value) and a higher water vapor permeability as compared to a comparative polymer foam without nano-crystalline cellulose.

### BRIEF DESCRIPTION OF THE DRAWINGS

FIG. 1 is a schematic drawing of an exemplary extrusion apparatus useful for making a polymer foam as described herein;

FIG. 2 is a graph of thermal conductivity (k-value) at 30 days aging for various extruded polystyrene foams as described in the Examples section herein; and

FIG. 3 is a graph of the water vapor permeability for various extruded polystyrene foams as described in the Examples section herein.

### DETAILED DESCRIPTION

Disclosed herein is a polymer foam, a composition for forming a polymer foam, and a method of making a polymer foam. The polymer foam includes nano-crystalline cellulose, which provides the polymer foam with a reduced thermal conductivity and a higher water vapor permeability as compared to a comparative polymer foam that does not include nano-crystalline cellulose. While the present disclosure describes certain embodiments of the polymer foam, the composition for forming the polymer foam, and the method of making the polymer foam in detail, the present disclosure is to be considered exemplary and is not intended to be limited to the disclosed embodiments.

Unless otherwise defined, all technical and scientific terms used herein have the same meaning as commonly understood by one of ordinary skill in the art to which the exemplary embodiments described herein belong. The terminology used in the description herein is for describing particular exemplary embodiments only and is not intended to be limiting of the exemplary embodiments. Accordingly, the general inventive concepts described herein are not intended to be limited to the specific embodiments described herein. Although any methods and materials similar or equivalent to those described herein can be used in the practice or testing of the present invention, the preferred methods and materials are described herein.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of 1 to 10 should be construed as supporting a range of 2 to 8, 3 to 7, 5 to 6, 1 to 9, 3.6 to 4.6, 3.5 to 9.9, and so forth.

Any combination of method or process steps as used herein may be performed in any order, unless otherwise specified or clearly implied to the contrary by the context in which the referenced combination is made.

The present disclosure relates to a composition and method of making a polymer foam that includes nano-crystalline cellulose to achieve a polymer foam that exhibits increased water vapor permeability and reduced thermal conductivity as compared to an otherwise identical polymer foam that does not include nano-crystalline cellulose. It was discovered that nano-crystalline cellulose, when incorporated in sufficient amounts into a polymer foam, functions as an infrared attenuating agent to reduce thermal conductivity and also improves the breathability of the polymer foam by increasing the water vapor permeability of the polymer foam.

In accordance with one exemplary embodiment, a composition for forming a polymer foam is provided. The composition for forming a polymer foam comprises a polymer, 2% to 10% by weight nano-crystalline cellulose based on the total weight of the solids of the composition, and at least one blowing agent. In certain embodiments, the composition for forming a polymer foam may further include one or more additives to improve the processing of the composition or the functionality of the resulting polymer foam.

The polymer is the backbone of the composition for forming the polymer foam and provides strength, flexibility, toughness, and durability to the final polymer foam product. The polymer that may be used in the composition is not particularly limited, and generally, any polymer capable of being foamed may be used as the polymer in the exemplary compositions described herein. The polymer may be thermoplastic or thermoset. The polymer used in the composition may be selected to provide sufficient mechanical strength to the resulting polymer foam, or may be selected based on the process used to form the polymer foam. In addition, the polymer is preferably chemically stable, that is, generally non-reactive, within the expected temperature range during formation and subsequent use of the resulting polymer foam.

As used herein, the term “polymer” is generic to the terms “homopolymer,” “copolymer,” “terpolymer,” and combinations of homopolymers, copolymers, and/or terpolymers. Non-limiting examples of suitable polymers that may be used in the composition include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyphenylene sulfide, acetal resins, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

In certain exemplary embodiments, the polymer is an alkenyl aromatic polymer. Exemplary alkenyl aromatic polymers include, but are not limited to, alkenyl aromatic homopolymers and copolymers of alkenyl aromatic compounds and copolymerizable ethylenically unsaturated co-monomers. In certain embodiments, the alkenyl aromatic polymer may include minor proportions (e.g., less than 10% by weight) of non-alkenyl aromatic polymers. In certain embodiments, the alkenyl aromatic polymer may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer. In certain embodiments, the alkenyl aromatic polymer comprises at least 50% by weight alkenyl aromatic monomer units. In certain embodiments, the alkenyl aromatic polymer comprises at least 70% by weight alkenyl aromatic monomer units, including at least 80% by weight alkenyl aromatic monomer units, at least 90% by weight alkenyl aromatic monomer units, and also including at least 95% by weight alkenyl aromatic monomer units. In certain embodiments, the alkenyl aromatic polymer is comprised entirely of alkenyl aromatic monomeric units.

Examples of alkenyl aromatic polymers that may be used in the compositions described herein include, but are not limited to, alkenyl aromatic polymers derived from alkenyl aromatic monomers such as styrene, alpha-methylstyrene, ethylstyrene, vinyl toluene, chlorostyrene, and bromostyrene. In certain embodiments, the alkenyl aromatic polymer used in the compositions described herein is polystyrene.

In certain exemplary embodiments, minor amounts (e.g., less than 10% by weight) of monoethylenically unsaturated monomers such as C2 to C6 alkyl acids and esters, ionomeric derivatives, and C2 to C6 dienes may be copolymerized with alkenyl aromatic monomers to form the alkenyl aromatic polymer. Non-limiting examples of such copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate, and butadiene.

In certain exemplary embodiments, the polymer of the composition comprises at least 90% by weight polystyrene. In certain exemplary embodiments, the polymer of the composition consists of polystyrene. In certain exemplary embodiments, the composition for forming a polymer foam comprises from 60% to 98% by weight polymer, including from 75% to 98% by weight polymer, from 85% to 98% by weight polymer, from 90% to 98% by weight polymer, and also including from 92% to 96% by weight polymer. The term “% by weight” as used herein, unless otherwise specified, refers to a percentage based on the total weight of the components of the composition, excluding the blowing agent. In other words, the term “% by weight” refers to a percentage based on the total weight of the solids of the composition.

The exemplary composition for forming a polymer foam comprises from 2% to 10% by weight nano-crystalline cellulose based on the total weight of the solids of the composition. Nano-crystalline cellulose may be obtained from the acid hydrolysis of cellulose fibers. The nano-crystalline cellulose may be sourced from a variety of materials (e.g., plants microorganisms, algae, sea animals) including, but not limited to, wood pulp, cotton, ramie, hemp, flax, sisal, wheat, straw, palm, sugar beet pulp, bacterial cellulose, Valonia algae, and tunicates. Examples of commercially available nano-crystalline cellulose that may be used in the exemplary compositions and polymer foams described herein include BioPlus-L™ crystals from American Process, Inc. (Atlanta, Ga.) and Celluforce NCC™ nano-crystalline cellulose from Celluforce (Montreal, Canada).

The nano-crystalline cellulose is generally in the form of rod-like or whisker-shaped particles with at least one dimension (e.g., length, width, diameter) less than 100 nm. In certain embodiments, the nano-crystalline cellulose has an average particle diameter (or width) of 2 nm to 5 nm, including from 2.3 nm to 4.5 nm, and also including an average particle diameter (or width) of 4 nm to 5 nm. In certain embodiments, the nano-crystalline cellulose has an average particle length of 40 nm to 500 nm, including from 40 nm to 400 nm, from 40 nm to 300 nm, from 40 nm to 200 nm, from 40 nm to 150 nm, and also including an average particle length of 40 nm to 115 nm. In certain embodiments, the nano-crystalline cellulose in the composition for forming a polymer foam has an average particle diameter (or width) of 2 nm to 5 nm and an average particle length of 40 nm to 115 nm.

In addition to physical dimensions, the nano-crystalline cellulose in the exemplary compositions described herein may also be characterized by other properties including, but not limited to, crystallinity, bulk density, sulfur content, zeta potential, and crystallinity index. In certain embodiments, the nano-crystalline cellulose has a crystallinity of 85% to 98%, including from 85% to 95%, and also including from 88% to 93%. In certain embodiments, the nano-crystalline cellulose has a bulk density of 0.5 g/cm³ to 1.5 g/cm³, including from 0.7 g/cm³ to 1.5 g/cm³, and also including from 1 g/cm³ to 1.5 g/cm³. In certain embodiments, the nano-crystalline cellulose comprises 0.05% to 1% by weight sulfur, including from 0.05% to 0.9% by weight sulfur, from 0.05% to 0.1% by weight sulfur, and also including from 0.85% to 0.9% by weight sulfur. In certain embodiments, the nano-crystalline cellulose has a zeta potential of −25 mV to −40 mV, including from −25 mV to −30 mV, and also including from −30 mV to −40 mV. In certain embodiments, the nano-crystalline cellulose has a crystallinity index of 40% to 80%, including from 40% to 70%, and also including from 40% to 65%.

In certain embodiments, the nano-crystalline cellulose in the composition for forming a polymer foam has an average particle diameter of 2 nm to 5 nm, an average particle length of 40 nm to 500 nm, and a zeta potential of −25 mV to −40 mV. In certain embodiments, the nano-crystalline cellulose in the composition for forming a polymer foam has an average particle diameter of 2 nm to 5 nm, an average particle length of 40 nm to 115 nm, and a zeta potential of −29.5 mV to −37 mV.

The nano-crystalline cellulose may be provided in the composition as part of a masterbatch. For example, the nano-crystalline cellulose may be extrusion compounded with a carrier polymer to form a nano-crystalline cellulose masterbatch. In certain embodiments, the nano-crystalline cellulose comprises 5% to 25% by weight of the masterbatch (based on the total weight of the masterbatch), including from 5% to 20%, from 5% to 15%, and also including from 5% to 10% by weight of the masterbatch. The carrier polymer may be the same polymer used in the composition for forming the polymer foam, or may be a different polymer than the polymer used in the composition for forming the polymer foam. In certain embodiments, the carrier polymer used to form the nano-crystalline cellulose masterbatch comprises polystyrene. In certain other embodiments, the carrier polymer used to form the nano-crystalline cellulose masterbatch consists of polystyrene.

It was discovered that the nano-crystalline cellulose, when used in sufficient amounts, functions as an infrared attenuating agent in the polymer foam, which reduces the thermal conductivity of the polymer foam and, thus, increases the insulating capability of the polymer foam. Without wishing to be bound by theory, it is believed the infrared attenuating functionality results from the abundant number of C—OH bonds present in the nano-crystalline cellulose, which can absorb infrared radiation. It was also discovered that the nano-crystalline cellulose, when used in sufficient amounts, efficiently increases the water vapor permeability of the polymer foam, which makes the polymer foam more breathable. When the polymer foam is used as a thermal insulation in or on the exterior of buildings, such breathability can reduce the risk of mold growth due moisture condensation and/or accumulation. Without wishing to be bound by theory, it is believed the hydrophilic nature of the nano-crystalline cellulose increases the water vapor permeability of the polymer foam.

As previously mentioned, the exemplary composition for forming a polymer foam comprises from 2% to 10% by weight nano-crystalline cellulose based on the total weight of the solids of the composition. In certain embodiments, the composition for forming a polymer foam comprises from 4% to 10% by weight nano-crystalline cellulose based on the total weight of the solids of the composition. In certain other embodiments, the composition for forming a polymer foam comprises from 4% to 8% by weight nano-crystalline cellulose based on the total weight of the solids of the composition. In certain embodiments, the composition for forming a polymer foam comprises from 4% to 8% by weight nano-crystalline cellulose based on the total weight of the solids of the composition, and the nano-crystalline cellulose has an average particle diameter of 2 nm to 5 nm, an average particle length of 40 nm to 115 nm, and a zeta potential of −29.5 mV to −37 mV. It is contemplated that the nano-crystalline cellulose in the composition for forming the polymer foam may be characterized by any combination of the physical dimensions and other properties described above.

The exemplary composition for forming a polymer foam also includes a blowing agent. Generally, any blowing agent suitable for making a polymer foam may be used in accordance with the present disclosure. However, due to increased concern over global warming and ozone depletion, in certain exemplary embodiments, the composition for forming a polymer foam is free of chlorofluorocarbon (CFC) blowing agents. The blowing agent may be selected based on the considerations of low global warming potential, low thermal conductivity, non-flammability, high solubility in polystyrene, high blowing power, low cost, and the overall safety of the blowing agent. The blowing agents described herein may be used alone or in combination in the composition for forming the polymer foam.

In certain embodiments, the blowing agent comprises a hydrofluorocarbon (“HFC”). In exemplary embodiments utilizing an HFC, the specific HFC utilized is not particularly limited. Exemplary HFCs suitable for use as a blowing agent in the composition for forming the polymer foam include, but are not limited to, 1,1-difluoroethane (HFC-152a); difluoroethane (HFC-152); 1,1,1,2-tetrafluoroethane (HFC-134a); 1,1,2,2-tetrafluoroethane (HFC-134); 1,1,1-trifluoroethane (HFC-143a); difluoromethane (“HFC-32”); pentafluoroethane (HFC-125); fluoroethane (HFC-161); 1,1,2,2,3,3-hexafluoropropane (HFC-236ca); 1,1,1,2,3,3-hexafluoropropane (HFC-236ea); 1,1,1,3,3,3-hexafluoropropane (HFC-236fa); 1,1,1,2,2,3-hexafluoropropane (HFC-245ca); 1,1,2,3,3-pentafluoropropane (HFC-245ea); 1,1,1,2,3-pentafluoropropane (HFC-245eb); 1,1,1,3,3-pentafluoropropane (HFC-245fa); 1,1,1,4,4,4-hexafluorobutane (HFC-356mff); 1,1,1,3,3-pentafluorobutane (HFC-365mfc); and combinations thereof.

In certain embodiments, the blowing agent used in the composition comprises at least one of HFC-134a, HFC-134, and HFC-152a. In certain embodiments, the blowing agent used in the composition comprises HFC-134a, HFC-134, and HFC-152a, wherein the amount of HFC-134a comprises from 15% to 85% by weight of the blowing agent, the amount of HFC-134 comprises from 5% to 20% by weight of the blowing agent, and the amount of HFC-152a comprises from 10% to 80% by weight of the blowing agent. In certain embodiments, the blowing agent used in the composition comprises HFC-134a, HFC-134, and HFC-152a, wherein the amount of HFC-134a comprises from 35% to 45% by weight of the blowing agent, the amount of HFC-134 comprises from 5% to 15% by weight of the blowing agent, and the amount of HFC-152a comprises from 45% to 55% by weight of the blowing agent. In certain embodiments, the blowing agent used in the composition comprises HFC-134a, HFC-134, and HFC-152a, wherein the amount of HFC-134a comprises 41% by weight of the blowing agent, the amount of HFC-134 comprises 9% by weight of the blowing agent, and the amount of HFC-152a comprises 50% by weight of the blowing agent.

In certain embodiments, the blowing agent may comprise a hydrofluoroolefin (HFO). In exemplary embodiments utilizing an HFO, the specific HFO utilized is not particularly limited. Exemplary HFOs suitable for use as a blowing agent in the composition for forming the polymer foam include, but are not limited to, trans-1-chloro-3,3,3-trifluoropropene (HFO-1233zd); 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336m/z); cis-1,1,1,4,4,4-Hexafluoro-2-butene (HFO-1336mzz(Z)); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-1-butene; 3,3-difluoro-1-butene; 3,4,4-trifluoro-1-butene; 2,3,3-trifluoro-1-butene; 1,1,3,3-tetrafluoro-1-butene; 1,4,4,4-tetrafluoro-1-butene; 3,3,4,4-tetrafluoro-1-butene; 4,4-difluoro-1-butene; 1,1,1-trifluoro-2-butene; 2,4,4,4-tetrafluoro-1-butene; 1,1,1,2-tetrafluoro-2 butene; 1,1,4,4,4-pentafluorol-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. In certain embodiments, the blowing agent comprises HFO-1234ze.

In certain embodiments, the blowing agent used in the composition comprises an HFC and an HFO. In certain embodiments, the blowing agent used in the composition comprises HFC-152a and HFO-1234ze, wherein the amount of HFC-152a comprises from 40% to 60% by weight of the blowing agent and the amount of HFO-1234ze comprises from 40% to 60% by weight of the blowing agent.

The blowing agent may be in the form of a liquid or gas (e.g., a physical blowing agent) or may be generated in situ during production of the foam (e.g., a chemical blowing agent). For instance, the blowing agent may be formed by decomposition of another constituent during production of the polymer foam. For example, a carbonate composition, polycarbonic acid, sodium bicarbonate, or azodicarbonamide and others that decompose and/or degrade to form nitrogen (N₂), carbon dioxide (CO₂), and water (H₂O) upon heating may be added to the composition. Other blowing agents useful in the practice of this disclosure include, but are not limited to, C2 to C9 aliphatic hydrocarbons (e.g., ethane, propane, n-butane, cyclopentane, isobutane, n-pentane, isopentane, and neopentane); C1 to C5 aliphatic alcohols (e.g., methanol, ethanol, n-propanol, isopropanol, and butanol); atmospheric gases such as air, carbon dioxide (CO₂), nitrogen (N₂), and/or argon (Ar); water; ketones (e.g., acetone and methyl ethyl ketone); ethers (e.g., dimethyl ethers and diethyl ethers); methyl formate; acetone; and hydrogen peroxide.

The amount of blowing agent used in the exemplary composition for forming the polymer foam is generally from 1% to 15% by weight based upon the total weight of all ingredients in the composition excluding the blowing agent. In certain embodiments, the blowing agent is present in an amount of 3% to 12% by weight, including from 5% to 10% by weight, and also including about 7.8% by weight based upon the total weight of all ingredients in the composition excluding the blowing agent.

The exemplary composition for forming a polymer foam may also contain one or more additives including, but not limited to, fire retarding agents, nucleating agents, plasticizing agents, pigments, elastomers, extrusion aids, antioxidants, fillers, antistatic agents, biocides, termiticides, colorants, oils, waxes, flame retardant synergists, infrared attenuating agents, and UV absorbers. The additives may be included in the composition in amounts necessary to obtain desired characteristics of the composition during processing or the resulting polymer foam.

In certain embodiments, the composition for forming a polymer foam includes a fire retarding agent in an amount up to 5% by weight, including from 1% to 5% by weight based upon the total weight of all ingredients in the composition excluding the blowing agent. Non-limiting examples of suitable fire retarding agents for use in the exemplary compositions described herein include brominated aliphatic compounds such as hexabromocyclododecane (HBCD) and pentabromocyclohexane, brominated phenyl ethers, esters of tetrabromophthalic acid, halogenated polymeric flame retardant such as brominated polymeric flame retardant based on styrene butadiene copolymers, phosphoric compounds, and combinations thereof.

In certain embodiments, the composition for forming a polymer foam includes a nucleating agent in an amount up to 2% by weight, including from 0.2% to 2%, from 0.2% to 1%, and also including from 0.3% to 0.5% by weight based upon the total weight of all ingredients in the composition excluding the blowing agent. Non-limiting examples of suitable nucleating agents for use in the exemplary compositions described herein include talc, graphite, titanium dioxide, kaolin, and combinations thereof.

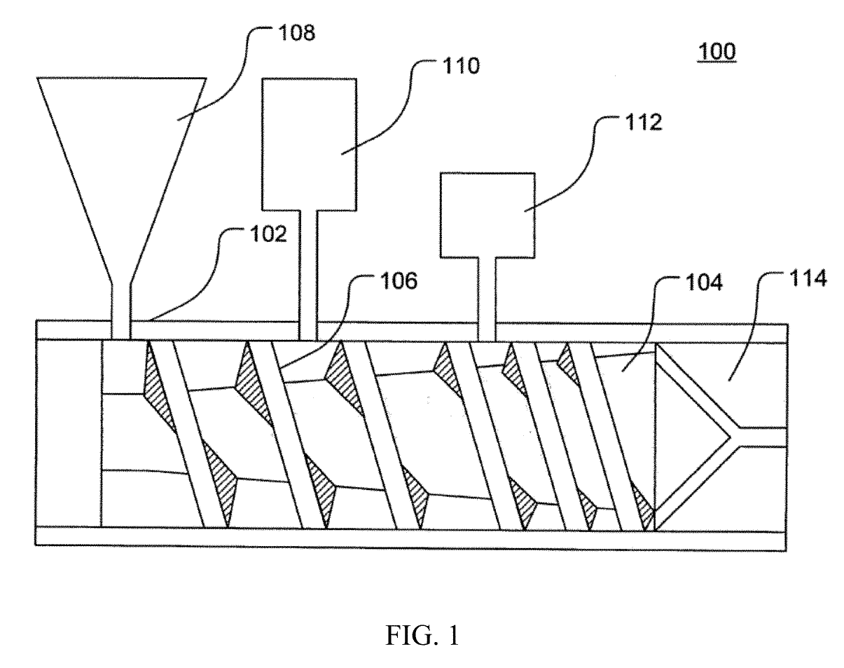

The exemplary polymer foam of the present disclosure may be made in a variety of ways. In one exemplary embodiment, the polymer foam is made using an extrusion process. FIG. 1 illustrates a traditional extrusion apparatus 100 useful for making a polymer foam of the present disclosure. The extrusion apparatus 100 may comprise a single or twin (not shown) screw extruder including a barrel 102 surrounding a screw 104 on which is provided a spiral flight 106 configured to compress, and thereby, heat material introduced into the screw extruder 100. As illustrated in FIG. 1, a polymer may be fed into the screw extruder 100 as a flowable solid, such as beads, granules or pellets, or as a liquid or semi-liquid polymer melt, from one or more feed hoppers 108.

As the polymer advances through the screw extruder 100, the decreasing spacing of the flight 106 defines a successively smaller space through which the polymer is forced by the rotation of the screw 104. This decreasing volume acts to increase the temperature of the polymer to obtain a polymer melt (if solid starting material was used) and/or to increase the temperature of the polymer melt.

As the polymer advances through the screw extruder 100, one or more ports may be provided through the barrel 102 with associated apparatus 110 configured for injecting nano-crystalline cellulose (or nano-crystalline cellulose masterbatch) and/or one or more optional additives into the polymer to form a polymer melt. Similarly, one or more ports may be provided through the barrel 102 with associated apparatus 112 configured for injecting one or more blowing agents into the polymer melt to form a foamable mixture. In certain embodiments, the nano-crystalline cellulose (or nano-crystalline cellulose masterbatch) is added into the feed hopper 108 along with the polymer. After the foamable mixture is formed, the foamable mixture may be subjected to additional blending in the screw extruder 100 sufficient to distribute each of the components generally uniformly throughout the foamable mixture.

The foamable mixture is then extruded through an extrusion die 114 and exits the die 114 into a region of reduced pressure (which may be above, or more typically below, atmospheric pressure), thereby allowing the blowing agent to expand and produce a polymer foam with cells that contain the expanded blowing agent. The pressure reduction may be obtained gradually as the extruded foamable mixture advances through successively larger openings provided in the die 114 or through some suitable apparatus (not shown) provided downstream of the extrusion die 114 for controlling to some degree the manner in which the pressure applied to the foamable mixture is reduced. The resulting polymer foam material may be subjected to additional processing such as calendaring, water immersion, cooling sprays, or other operations to control the thickness and other properties of the resulting polymer foam product.

In certain embodiments, the polymer foam formed from the exemplary compositions disclosed herein is a rigid, substantially closed cell, polymer foam board prepared by an extruding process. Such extruded polymer foams generally have a cellular structure with cells defined by cell membranes and struts. Struts are formed at the intersection of the cell membranes, with the cell membranes covering interconnecting cellular windows between the struts. In certain embodiments, the average cell size of the polymer foam is from 0.05 mm (50 microns) to 0.4 mm (400 microns), including from 0.1 mm (100 microns) to 0.3 mm (300 microns), and also including from 0.11 mm (110 microns) to 0.25 mm (250 microns).

It is to be appreciated that the phrase “substantially closed cell” is meant to indicate that the foam contains all closed cells or nearly all the cells in the cellular structure are closed. In certain exemplary embodiments, no more than 5% of the cells are open cells, or otherwise “non-closed” cells. In certain embodiments, from 0.01% to 5% of the cells of the polymer foam are open cells. In certain embodiments, from 0.01% to 2% of the cells of the polymer foam are open cells. In certain embodiments, from 0.4% to 1.25% of the cells of the polymer foam are open cells.

In certain embodiments, the polymer foam formed from the exemplary compositions disclosed herein have a density of less than 10 lb/ft³ (pcf), or less than 5 pcf, or less than 3 pcf. In certain embodiments, the polymer foam has a density of 1.2 pcf to 4.5 pcf. In certain embodiments, the polymer foam has a density of 1.5 pcf to 2.5 pcf. In certain embodiments, the polymer foam has a density of 1.8 pcf to 2.1 pcf. In certain embodiments, the polymer foam has a density of 1.8 pcf to 2 pcf.

In certain embodiments, the polymer foam formed from the exemplary compositions disclosed herein possess a high level of dimensional stability. For example, in certain embodiments, the polymer foam formed from the exemplary compositions disclosed herein has a dimensional stability of 0% to 5% maximum dimensional change in any direction, at a temperature of 160° F. to 180° F.

The polymer foams produced from the exemplary compositions disclosed herein, which include from 2% by weight to 10% by weight nano-crystalline cellulose, were discovered to exhibit increased water vapor permeability and reduced thermal conductivity as compared to otherwise identical polymer foams that do not include nano-crystalline cellulose. In certain embodiments, the polymer foam produced from the exemplary compositions disclosed herein has a water vapor permeability of 0.1 perm·inch to 1.5 perm·inch, including from 1 perm·inch to 1.5 perm·inch, from 1.1 perm·inch to 1.5 perm·inch, from 1.2 perm·inch to 1.4 perm·inch, and also including a water vapor permeability of 1.23 perm·inch to 1.4 perm·inch. Such water vapor permeability values, particularly water vapor permeability values of at least 1.23 perm·inch, provide for the enhanced breathability of the polymer foam, which can reduce the risk of mold growth due moisture condensation and/or accumulation, particularly when the polymer foam is used as a thermal insulation product for buildings.

As previously mentioned, it was discovered that nano-crystalline cellulose functions as an infrared attenuating agent, which can reduce the thermal conductivity and increase the thermal resistance (R-value) of a polymer foam. In certain embodiments, the polymer foam produced from the exemplary compositions disclosed herein has a thermal conductivity of 0.154 BTU·in/(hr·ft²·° F.) to 0.222 BTU·in/(hr·ft²·° F.), including from 0.175 BTU·in/(hr·ft²·° F.) to 0.220 BTU·in/(hr·ft²·° F.), from 0.185 BTU·in/(hr·ft²·° F.) to 0.210 BTU·in/(hr·ft²·° F.), from 0.190 BTU·in/(hr·ft²·° F.) to 0.205 BTU·in/(hr·ft²·° F.), and also including from 0.195 BTU·in/(hr·ft²·° F.) to 0.199 BTU·in/(hr·ft²·° F.). In certain embodiments, the polymer foam produced from the exemplary compositions disclosed herein has an R-value per inch of at least 4, including from 4 to 6.5, from 4.5 to 6.25, and also including from 5 to 6. In certain embodiments, the polymer foam produced from the exemplary compositions disclosed herein has an R-value per inch of about 5.

The polymer foam produced from the exemplary compositions disclosed herein may be formed into an insulation product such as a rigid insulation board, an insulation foam, a packaging product, and building insulation or underground insulation (for example, highway, airport runway, railway, and underground utility insulation).

The inventive concepts have been described above both generically and with regard to various exemplary embodiments. Although the general inventive concepts have been set forth in what is believed to be exemplary illustrative embodiments, a variety of alternatives known to those of skill in the art can be selected within the generic disclosure. Additionally, the following examples are meant to better illustrate the inventive concepts, but are in no way intended to limit the general inventive concepts of the present disclosure.

### Examples

A series of exemplary and comparative extruded polystyrene (“XPS”) foams were prepared using a tandem extrusion system having a primary twin screw extruder and a secondary single screw extruder. The resulting XPS foams were evaluated to determine various properties such as density (using ASTM D1622), average cell size (using ASTM D3576), open cell content (using ASTM D6226), thermal conductivity (using ASTM C518), and water vapor permeability (using ASTM E96).

To make the XPS foams, the following raw materials were fed into the feed hopper at the front end of the primary extruder: polystyrene, nano-crystalline cellulose masterbatch, a flame retardant (e.g., hexabromocyclododecane, polymeric brominated styrene butadiene), and talc (nucleating agent). The blowing agent used to form the XPS foams was added into a separate port in the middle of the primary extruder and comprised a tertiary blend of HFC-134a (about 41% by weight), HFC-134 (about 9% by weight), and HFC-152a (about 50% by weight). The primary extruder was used to melt and mix the various components fed into the primary extruder to create a homogeneous composition. The melting and mixing process performed in the primary extruder was completed at about 200° C. and a pressure above 2,000 psi. The homogeneous composition was then pushed from the exit of the primary extruder into the secondary extruder, where it was cooled from about 200° C. to the eventual foaming temperature of about 120° C. The rotation speed of the screw of the secondary extruder was much slower than the rotation speed of the screws of the primary extruder to ensure a long residence time for heat exchange and cooling. From the secondary extruder, the homogeneous composition flowed through a flat face foaming die where pressure was reduced to initiate foam cell nucleation and growth. The foaming die temperature was about 110° C. to 130° C. and the foaming die pressure was about 600 psi to about 1500 psi. After the foaming die, the foamed polymer was compressed in a shaping die. The resulting XPS foam board was trimmed and packaged. The extrusion system was operated at a production rate of approximately 230 pounds per hour. The XPS foam boards had a thickness of about 1 inch and an untrimmed width of about 24 inches.

Table 1 sets forth the components used to form the exemplary and comparative XPS foams, while Table 2 lists certain properties of the exemplary and comparative XPS foams. The percentages listed in the column labeled “Feed Hopper Components” in Table 1 refer to the percent by weight of the total solids fed to the feed hopper. The percentages listed in the column labeled “Port Component” in Table 1 refer to the percent by weight based upon the total weight of all components in the extruder excluding the blowing agent.

The nano-crystalline cellulose masterbatch was formed by extrusion compounding polystyrene (PS) with the nano-crystalline cellulose at 10% by weight of the total masterbatch. The nano-crystalline cellulose used in Control A and Examples 1-6 was BioPlus-L™ nano-crystalline cellulose (NCCA) from American Process, Inc. (Atlanta, Ga.), and the nano-crystalline cellulose used in Control B and Examples 7-12 was Celluforce NCC™ nano-crystalline cellulose (NCCB) from Celluforce (Montreal, Canada).

TABLE 1
XPS Foam Components

| | Feed Hopper Components | | | | | Port |
|---|---|---|---|---|---|---|
| | | | | Nano-Crystalline | | Component |
| | | Flame | | Cellulose Masterbatch | Actual Nano- | Blowing |
| Example No. | Polystyrene | Retardant | Talc | (90% PS, 10% NCC) | Crystalline Cellulose | Agent |
| Control A | 97.6% | 2% | 0.4% | 0% | 0% | 7.8% |
| (PL285-1) | | | | | | |
| 1 (PL285-2) | 92.6% | 2% | 0.4% | 5% | 0.5% | 7.8% |
| 2 (PL285-3) | 87.6% | 2% | 0.4% | 10% | 1% | 7.8% |
| 3 (PL285-4 | 88% | 2% | 0% | 10% | 1% | 7.8% |
| 4 (PL285-5) | 77.6% | 2% | 0.4% | 20% | 2% | 7.8% |
| 5 (PL285-6) | 57.6% | 2% | 0.4% | 40% | 4% | 7.8% |
| 6 (PL285-7) | 17.6% | 2% | 0.4% | 80% | 8% | 7.8% |
| Control B | 98.6% | 1% | 0.4% | 0% | 0% | 7.8% |
| (PL361-1) | | | | | | |
| 7 (PL361-2) | 93.6% | 1% | 0.4% | 5% | 0.5% | 7.8% |
| 8 (PL361-3) | 88.6% | 1% | 0.4% | 10% | 1% | 7.8% |
| 9 (PL361-4) | 89% | 1% | 0% | 10% | 1% | 7.8% |
| 10 (PL361-5) | 78.6% | 1% | 0.4% | 20% | 2% | 7.8% |
| 11 (PL361-6) | 58.6% | 1% | 0.4% | 40% | 4% | 7.8% |
| 12 (PL361-7) | 18.6% | 1% | 0.4% | 80% | 8% | 7.8% |

TABLE 2
XPS Foam Properties

| | | | | | Water |
|---|---|---|---|---|---|
| | | | | Thermal | Vapor |
| | | Average | Open | Conduc- | Perme- |
| | | Cell | Cell | tivity* | ability |
| | Density | Size | Content | (BTU · in/ | (perm · |
| Example No. | (lb/ft³) | (mm) | (%) | (hr · ft · ° F.) | inch) |
| Control A | 2.07 | 0.15 | 0.60 | 0.218 | 1.216 |
| (PL285-1) | | | | | |
| 1 (PL285-2) | 1.82 | 0.15 | 1.00 | 0.218 | 1.227 |
| 2 (PL285-3) | 1.85 | 0.15 | 0.09 | 0.217 | 1.189 |
| 3 (PL285-4 | 1.76 | 0.17 | 0.00 | 0.215 | 1.197 |
| 4 (PL285-5) | 1.82 | 0.15 | 0.01 | 0.217 | 1.237 |
| 5 (PL285-6) | 1.83 | 0.15 | 1.12 | 0.216 | 1.253 |
| 6 (PL285-7) | 1.86 | 0.15 | 1.12 | 0.213 | 1.379 |
| Control B | 1.81 | 0.20 | 1.26 | 0.1990 | 1.08 |
| (PL361-1) | | | | | |
| 7 (PL361-2) | 1.79 | 0.21 | 0.00 | 0.2009 | ND |
| 8 (PL361-3) | 1.79 | 0.20 | 0.83 | 0.1990 | 1.11 |
| 9 (PL361-4) | 1.61 | 0.37 | 6.25 | 0.2033 | ND |
| 10 (PL361-5) | 1.85 | 0.19 | 0.00 | 0.2006 | ND |
| 11 (PL361-6) | 1.87 | 0.18 | 0.49 | 0.1997 | 1.13 |
| 12 (PL361-7) | 2.06 | 0.15 | 0.46 | 0.1959 | 1.26 |

*Thermal conductivity values for Examples Control A and 1-6 are at 180 days aging. Thermal conductivity values for Examples Control B and 7-12 are at 30 days aging.
ND = Not determined

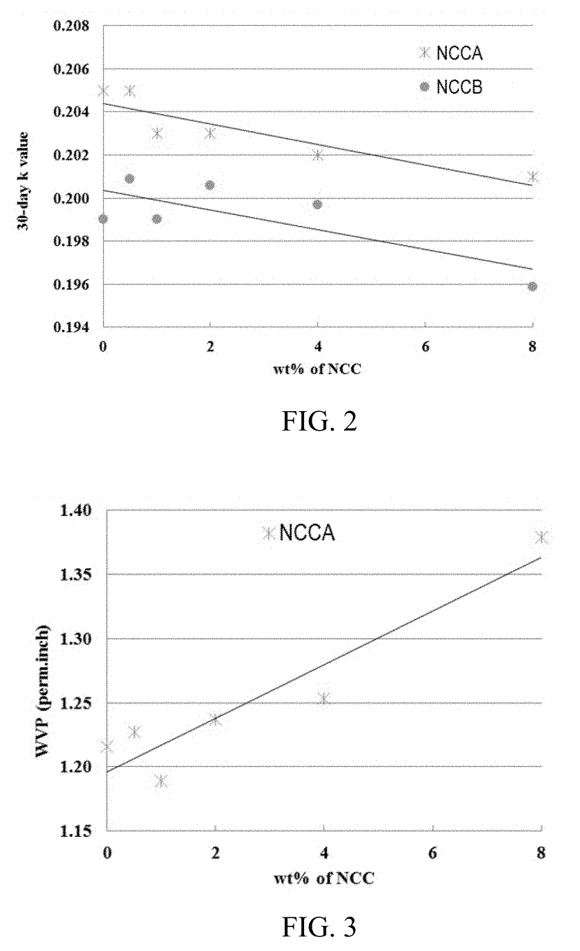

As illustrated in Table 2 and FIG. 2, it was discovered that the nano-crystalline cellulose incorporated into the XPS foam functions as an infrared attenuating agent, particularly at concentrations greater than 4% by weight, by reducing the thermal conductivity (k-value) of the XPS foam. For example, as compared to the Control A and the Control B XPS foams, which contain no nano-crystalline cellulose, the use of nano-crystalline cellulose at 8% by weight reduces the thermal conductivity of the XPS foam by about 0.003 BTU·in/(hr·ft·° F.) to about 0.005 BTU·in/(hr·ft·° F.). Such a reduction in thermal conductivity would result in the XPS foam having an improvement in the R-value per inch of about 0.1 to about 0.2. As seen in FIG. 2, each type of nano-crystalline cellulose used in the XPS foams show similar efficiency in reducing thermal conductivity, as illustrated by the parallel trend lines.

As illustrated in Table 2 and FIG. 3, it was discovered that the nano-crystalline cellulose incorporated into the XPS foam increases water vapor permeability, particularly at concentrations greater than 4% by weight. For example, as compared to the Control A XPS foam, which contains no nano-crystalline cellulose, the use of nano-crystalline cellulose at 8% by weight increases the water vapor permeability of the XPS foam by about 0.163 perm·inch, or about 13.4%. Such an increase in water vapor permeability would increase the breathability of the XPS foam, which can help avoid mold growth due to moisture condensation and/or accumulation.

As used in the specification and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A polymer foam formed from a composition comprising:
a polymer;
2% to 10% by weight nano-crystalline cellulose based on the total weight of the polymer foam; and
a blowing agent,
wherein the polymer foam exhibits a reduced thermal conductivity as compared to a comparative polymer foam without nano-crystalline cellulose, and
wherein the polymer foam exhibits a higher water vapor permeability as compared to a comparative polymer foam without nano-crystalline cellulose.

2. The polymer foam of claim 1, wherein the polymer comprises an alkenyl aromatic polymer.

3. The polymer foam of claim 1, wherein the polymer is selected from the group consisting of polystyrene, poly(alpha-methyl styrene), poly(chlorostyrene), poly(bromostyrene), poly(styrene-co-acrylonitrile), poly(styrene-co-methyl methacrylate), poly(styrene-co-maleic anhydride), acrylonitrile-styrene-acrylate copolymer, and combinations thereof.

4. The polymer foam of claim 1, wherein the polymer is polystyrene.

5. The polymer foam of claim 1, wherein the nano-crystalline cellulose is present in an amount of 4% to 8% by weight based on the total weight of the polymer foam.

6. The polymer foam of claim 1, wherein the polymer foam has a thermal conductivity of 0.154 BTU·in/(hr·ft²·° F.) to 0.222 BTU·in/(hr·ft²·° F.).

7. The polymer foam of claim 1, wherein the polymer foam has a water vapor permeability of 0.1 perm·inch to 1.5 perm·inch.

8. The polymer foam of claim 1, wherein the polymer foam has a density of 1.2 lb/ft³ to 4.5 lb/ft³.

9. The polymer foam of claim 1, wherein the polymer foam has a dimensional stability of 0% to 5% maximum dimensional change in any direction, at a temperature of 160° F. to 180° F.

10. The polymer foam of claim 1, wherein the nano-crystalline cellulose has an average particle diameter of 2 nm to 5 nm, an average particle length of 40 nm to 500 nm, and a zeta potential of −25 mV to −40 mV.

11. The polymer foam of claim 1, further comprising at least one of an infrared attenuating agent, a plasticizer, a flame retardant, a pigment, an elastomer, an extrusion aid, an antioxidant, a filler, an antistatic agent, a UV absorber, a citric acid, a surfactant, and a processing aid.

12. The polymer foam of claim 1, wherein the blowing agent comprises at least one of a hydrofluorocarbon, a hydrofluoroolefin, a C2 to C9 aliphatic hydrocarbon, a C1 to C5 aliphatic alcohol, an atmospheric gas, water, and methyl formate.

13. The polymer foam of claim 1, wherein the blowing agent comprises at least one of 1,1,1,2-tetrafluoroethane (HFC-134a), 1,1-difluoroethane (HFC-152a), 1,2-difluoroethane (HFC-152), 1,1,2,2-tetrafluoroethane (HFC-134), (cis and/or trans)-1,3,3,3-tetrafluoropropene (HFO-1234ze), trans-1-chloro-3,3,3-trifluoropropene (HFO-1233zd), cis-1,1,1,4,4,4-Hexafluoro-2-butene (HFO-1336mzz-Z), ethanol, carbon dioxide (CO₂), ethane, propane, n-butane, cyclopentane, isobutane, n-pentane, isopentane, neopentane, methanol, ethanol, n-propanol, isopropanol, butanol, water, and methyl formate.

14. The polymer foam of claim 1, wherein the blowing agent comprises 1,1,1,2-tetrafluoroethane (HFC-134a), 1,1-difluoroethane (HFC-152a), and 1,1,2,2-tetrafluoroethane (HFC-134).

15. The polymer foam of claim 1, further comprising at least one of talc, graphite, titanium dioxide, and kaolin.

16. A polymer foam composition comprising:
an alkenyl aromatic polymer; and
2% to 10% by weight of nano-crystalline cellulose based on the total weight of the polymer foam composition;
wherein when formed as a foam, the polymer foam exhibits a reduced thermal conductivity as compared to a comparative polymer foam without nano-crystalline cellulose, and
wherein when formed as a foam, the polymer foam exhibits a higher water vapor permeability as compared to a comparative polymer foam without nano-crystalline cellulose.

17. An insulation board comprising the polymer foam of claim 1.
